(19) United States
(12) Patent Application Publication
(10) Pub. No.: US 2023/0281426 A1
(43) Pub. Date: Sep. 7, 2023

(54) ARTIFICIAL INTELLIGENCE WITH EXPLAINABILITY INSIGHTS

(71) Applicant: Cisco Technology, Inc., San Jose, CA (US)

(72) Inventors: Ali Payani, Santa Clara, CA (US); Ramana Rao V. R. KOMPELLA, Cupertino, CA (US)

(21) Appl. No.: 17/684,635

(22) Filed: Mar. 2, 2022

(51) Int. Cl. G06N 3/04; G06N 3/08

(52) U.S. Cl. CPC G06N 3/0427; G06N 3/08

(57) ABSTRACT

In one embodiment, a device makes an inference regarding input data using an artificial intelligence model. The device captures one or more feature vectors used by the artificial intelligence model to make the inference. The device selects, based on the one or more feature vectors, a representative sample from a training dataset used to train the artificial intelligence model. The device provides the representative sample for display in conjunction with the inference.

### TECHNICAL FIELD

The present disclosure relates generally to computer networks, and, more particularly, to artificial intelligence with explainability insights.

### BACKGROUND

Artificial intelligence is becoming increasingly ubiquitous in the field of computing. Indeed, artificial intelligence is now used across a wide variety of use cases, from analyzing sensor data from sensor systems to performing future predictions for controlled systems.

While artificial intelligence is quite capable of automating many computerized tasks and drawing inferences about various forms of input data, many artificial intelligence techniques today lack explainability. More specifically, there are certain forms of artificial intelligence techniques, such as neural networks, that do not provide any indication as to how they arrived at their conclusions. Consequently, users, developers, data scientists, and other interested parties are often left wondering why an artificial intelligence model behaved in a certain way.

### BRIEF DESCRIPTION OF THE DRAWINGS

The embodiments herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device/node;

FIG. 3 illustrates an example of an image classifier;

FIG. 4 illustrates an example architecture for extracting Boolean logic to explain classifications by an image classifier;

FIGS. 5A-5B illustrate example building blocks to generate explainable Boolean logic for a classifier;

FIG. 6 illustrates an example of learning and representing composite features as Boolean functions;

FIG. 7 illustrates an example decision rule generator;

FIG. 8 illustrates an example architecture for memorizing neural networks;

FIG. 9 illustrates an example display of classification results with explainability insights; and

FIG. 10 illustrates an example simplified procedure for providing explainability insights for an artificial intelligence model.

### DESCRIPTION OF EXAMPLE EMBODIMENTS

### Overview

According to one or more embodiments of the disclosure, a device makes an inference regarding input data using an artificial intelligence model. The device captures one or more feature vectors used by the artificial intelligence model to make the inference. The device selects, based on the one or more feature vectors, a representative sample from a training dataset used to train the artificial intelligence model. The device provides the representative sample for display in conjunction with the inference.

### Description

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

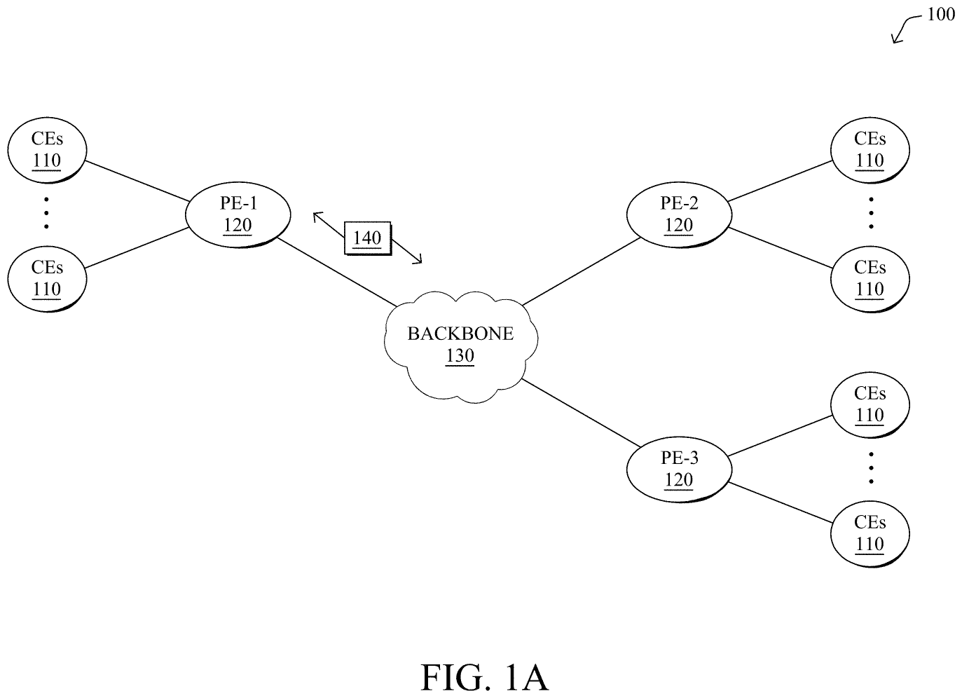

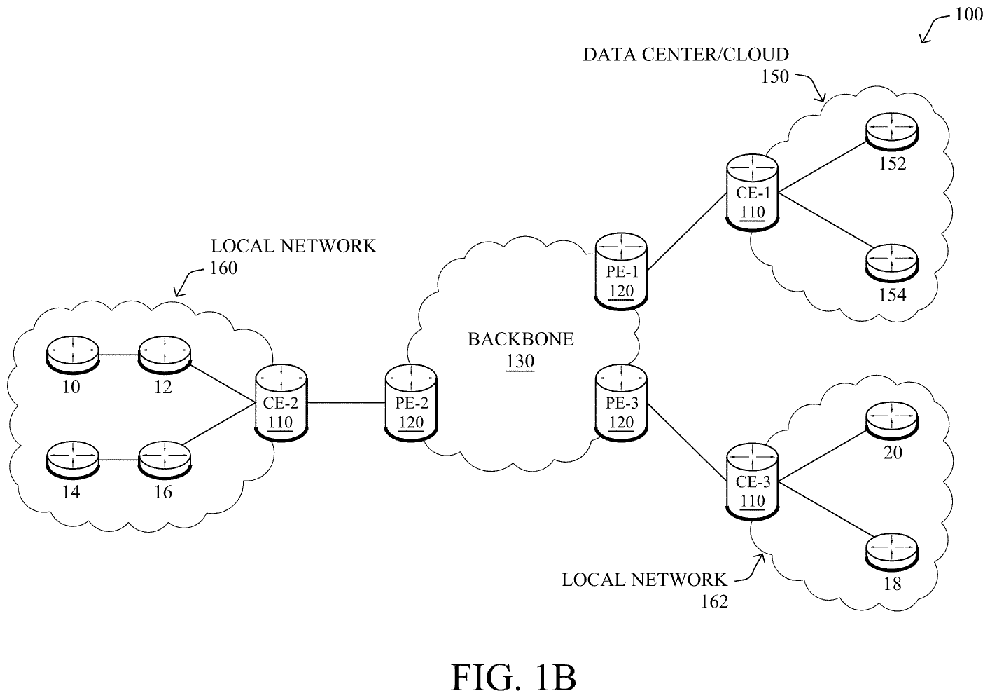

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:

1.) Site Type A: a site connected to the network (e.g., via a private or VPN link) using a single CE router and a single link, with potentially a backup link (e.g., a 3G/4G/5G/LTE backup connection). For example, a particular CE router 110 shown in network 100 may support a given customer site, potentially also with a backup link, such as a wireless connection.

2.) Site Type B: a site connected to the network by the CE router via two primary links (e.g., from different Service Providers), with potentially a backup link (e.g., a 3G/4G/5G/LTE connection). A site of type B may itself be of different types:

2a.) Site Type B 1: a site connected to the network using two MPLS VPN links (e.g., from different Service Providers), with potentially a backup link (e.g., a 3G/4G/5G/LTE connection).

2b.) Site Type B2: a site connected to the network using one MPLS VPN link and one link connected to the public Internet, with potentially a backup link (e.g., a 3G/4G/5G/LTE connection). For example, a particular customer site may be connected to network 100 via PE-3 and via a separate Internet connection, potentially also with a wireless backup link.

2c.) Site Type B3: a site connected to the network using two links connected to the public Internet, with potentially a backup link (e.g., a 3G/4G/5G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).

3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 110 connected to PE-2 and a second CE router 110 connected to PE-3.

FIG. 1B illustrates an example of network 100 in greater detail, according to various embodiments. As shown, network backbone 130 may provide connectivity between devices located in different geographical areas and/or different types of local networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various embodiments, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some embodiments, the techniques herein may be applied to other network topologies and configurations. For example, the techniques herein may be applied to peering points with high-speed links, data centers, etc.

According to various embodiments, a software-defined WAN (SD-WAN) may be used in network 100 to connect local network 160, local network 162, and data center/cloud environment 150. In general, an SD-WAN uses a software defined networking (SDN)-based approach to instantiate tunnels on top of the physical network and control routing decisions, accordingly. For example, as noted above, one tunnel may connect router CE-2 at the edge of local network 160 to router CE-1 at the edge of data center/cloud environment 150 over an MPLS or Internet-based service provider network in backbone 130. Similarly, a second tunnel may also connect these routers over a 4G/5G/LTE cellular service provider network. SD-WAN techniques allow the WAN functions to be virtualized, essentially forming a virtual connection between local network 160 and data center/cloud environment 150 on top of the various underlying connections. Another feature of SD-WAN is centralized management by a supervisory service that can monitor and adjust the various connections, as needed.

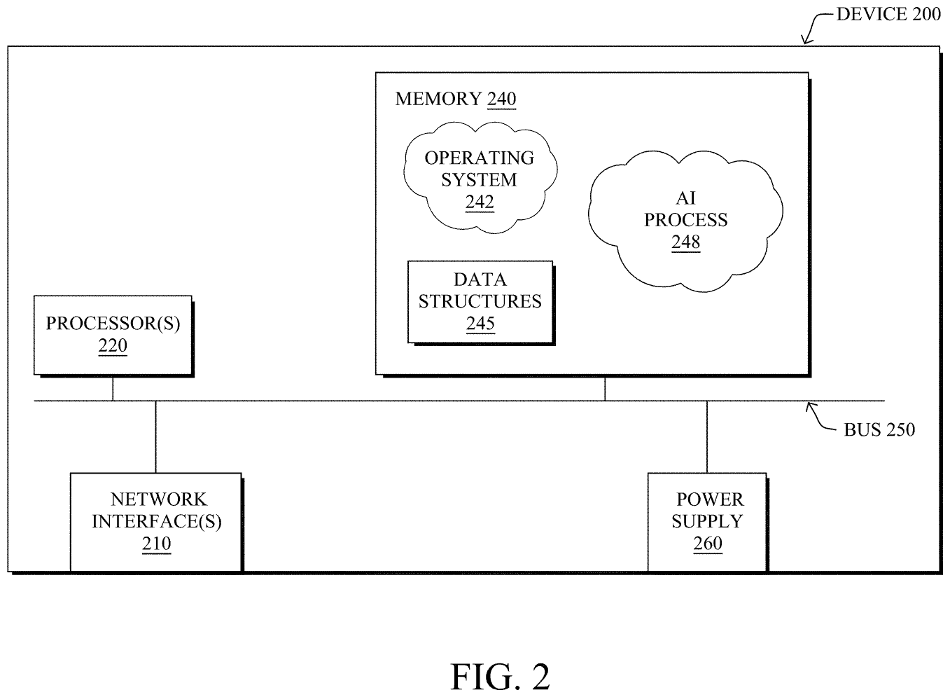

FIG. 2 is a schematic block diagram of an example node/device 200 (e.g., an apparatus) that may be used with one or more embodiments described herein, e.g., as any of the computing devices shown in FIGS. 1A-1B, particularly the PE routers 120, CE routers 110, nodes/device 10-20, servers 152-154 (e.g., a network controller/supervisory service located in a data center, etc.), any other computing device that supports the operations of network 100 (e.g., switches, etc.), or any of the other devices referenced below. The device 200 may also be any other suitable type of device depending upon the type of network architecture in place, such as IoT nodes, etc. Device 200 comprises one or more network interfaces 210, one or more processors 220, and a memory 240 interconnected by a system bus 250, and is powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the embodiments described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise an artificial intelligence (AI) process 248, as described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In various embodiments, as detailed further below, AI process 248 may also include computer executable instructions that, when executed by processor(s) 220, cause device 200 to perform the techniques described herein. To do so, in some embodiments, AI process 248 may utilize artificial intelligence/machine learning (ML). In general, AI/ML is concerned with the design and the development of techniques that take as input empirical data (such as network statistics and performance indicators), and recognize complex patterns in these data. One very common pattern among AI/ML techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a,b,c such that the number of misclassified points is minimal. After this optimization phase (or learning phase), the model M can be used very easily to classify new data points. Often, M is a statistical model, and the cost function is inversely proportional to the likelihood of M, given the input data.

In various embodiments, AI process 248 may employ, or be responsible for the deployment of, one or more supervised, unsupervised, or semi-supervised learning models. Generally, supervised learning entails the use of a training set of data, as noted above, that is used to train the model to apply labels to the input data. For example, the training data may include sample image data that has been labeled as depicting a particular condition or object. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example techniques that AI process 248 can employ, or be responsible for deploying, may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for time series), random forest classification, or the like.

As noted above, while AI is quite capable of automating many computerized tasks and drawing inferences about various forms of input data, many artificial intelligence techniques today lack explainability. More specifically, there are certain forms of artificial intelligence techniques, such as neural networks, that do not provide any indication as to how they arrived at their conclusions. Consequently, users, developers, data scientists, and other interested parties are often left wondering why an artificial intelligence model behaved in a certain way.

### Artificial Intelligence with Explainability Insights

The techniques introduced herein allow for explainability insights to be provided in conjunction with an inference made by an artificial intelligence (AI) model regarding input data. In some aspects, the explainability insights may take the form of one or more examples from the training dataset that was used to train the model. Such examples may be selected, for instance, by assigning memory units for the neurons of the model of interest (e.g., a feature layer of a convolutional model) and storing representative examples from the training dataset that correspond to that particular neuron. Thus, when the neuron is activated by the input data, the system can quickly identify the ‘closest’ representatives to that input data and provide it for display. In further aspects, the explainability insights may also take the form of Boolean rules/expressions that correspond to the reasoning made by the model to arrive at its inference. Such Boolean rules may be constructed using a differentiable neural logic model that is learned in conjunction with the artificial intelligence model and represents its reasoning in arriving at its inference about the input data. By providing the Boolean rule/expression to a user, they can better understand the combinations of factors/features used by the model to arrive at its conclusion about the input data.

Illustratively, the techniques described herein may be performed by hardware, software, and/or firmware, such as in accordance with AI process 248, which may include computer executable instructions executed by the processor 220 (or independent processor of interfaces 210) to perform functions relating to the techniques described herein.

Specifically, according to various embodiments, a device makes an inference regarding input data using an artificial intelligence model. The device captures one or more feature vectors used by the artificial intelligence model to make the inference. The device selects, based on the one or more feature vectors, a representative sample from a training dataset used to train the artificial intelligence model. The device provides the representative sample for display in conjunction with the inference.

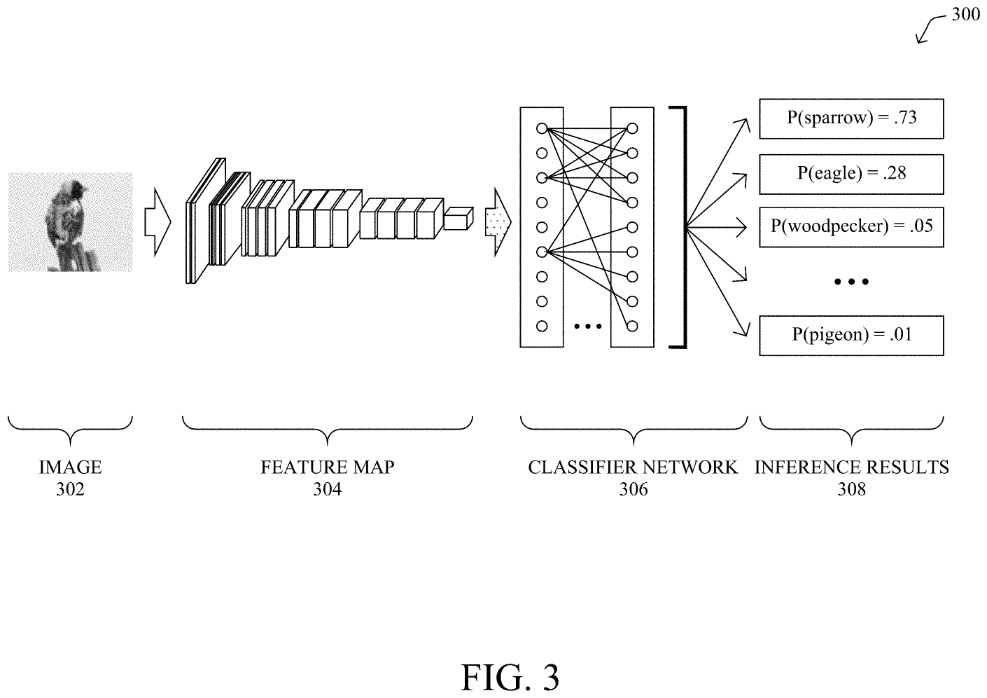

Operationally, FIG. 3 illustrates an example of an image classifier 300 which may be trained and/or executed as part of AI process 248, in various embodiments. As would be appreciated, in a standard neural network-based classifier model, a set of fully connected layers processes a vector of features (usually the output of the last layer of convolutional/pooling networks) to generate the probability estimate of each class corresponding to the input image. For instance, as shown, an input image 302 may be processed by various layers of image classifier 300 may include a feature map portion 304 that extracts feature vectors representing the various features present in input image 302. For instance, feature map portion 304 may take the form of a visual geometry group (VGG) network, a Resnet network, or the like, that produces a feature map/set of one or more feature vectors. In turn, a classifier network 306 may evaluate the various features extracted from input image 302 to produce an inference result 308.

For example, say that input image 302 depicts a sparrow. In such a case, the various features extracted by image classifier 300 may be its color, beak shape, wing shape, size, etc., the combination of which may be assessed by classifier network 306 to assign probabilities to different possible class labels as part of inference result 308. In this particular case, inference result 308 may indicate that the class label with the highest probability is a sparrow, followed by an eagle, a woodpecker, etc., with pigeon having the lowest probability of the possible bird types.

Since the fully connected neural networking layers of image classifier 300 are opaque networks with a very large number of parameters, inference result 308 is not directly explainable and is a complex function of the extracted feature vector(s) from input image 302. While some recent efforts have attempted to perform post-hoc analysis of the inference results, to ‘piece together’ a decision tree that estimates the reasoning of a classifier model, doing so also does not guarantee that the resulting decision tree actually matches the classification network. Moreover, since classifier networks are often learned during training using gradient optimization, this does not necessarily produce a result that can be well approximated via a decision tree.

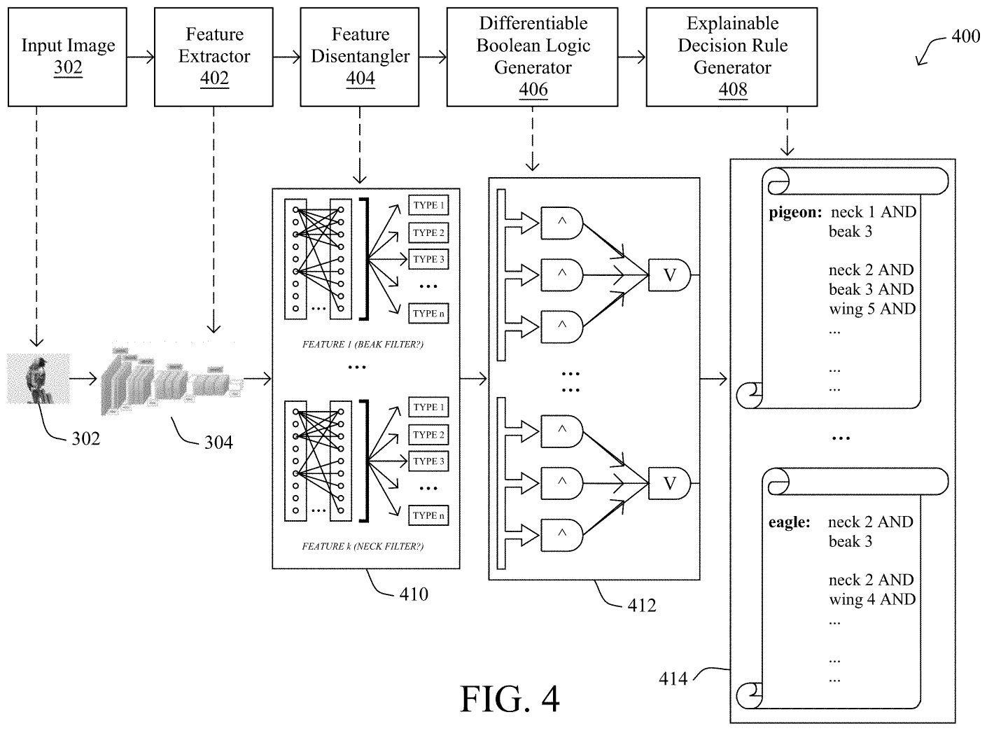

According to various embodiments, the techniques herein propose learning Boolean rules during the training of an AI model that correspond to each class in an end-to-end-fashion. In other words, the training of the Boolean rules may be performed via gradient optimization alongside the rest of the network trainable parameters, thereby eliminating the need for any post-hoc approximation. FIG. 4 illustrates an example architecture 400 for such an approach

FIG. 4 illustrates an example architecture 400 for extracting Boolean logic to explain classifications by an image classifier. At the core of architecture 500 are modules 402-408, which may be components of an AI process, such as AI process 248. More specifically, the AI process may comprise any or all of the following components: a feature extractor 402, a feature disentangler 404, a differential Boolean logic generator 406, and/or an explainable decision rule generator 408. As would be appreciated, the functionalities of these components may be combined or omitted, as desired. In addition, these components may be implemented on a singular device or in a distributed manner, in which case the combination of executing devices can be viewed as their own singular device for purposes of executing AI process 248.

During operation, an input image 302 may be used as input to feature extractor 402 that implements feature map portion 304 described previously with respect to FIG. 3 and generates feature vectors) that represent the various features of input image 302. From there, the resulting feature vector(s) may be input to feature disentangler 404 which, in various embodiments, comprises an unsupervised or semi-supervised feature classification network that is responsible for learning meaningful semantic information. In turn, the symbolic representations 410 learned by feature disentangler 404 may be processed by differential Boolean logic generator 406.

More specifically, for each feature represented by the feature vector(s) generated by feature extractor 402, feature disentangler 404 may determine the various sets of possible values/categories for each feature. For instance, in the case of input image 302 depicting a bird, one such feature may represent its beak type from among a set of possible beak types. Similarly, another feature may represent its neck type from among a set of possible neck types. In other words, feature disentangler 404 may learn the various features considered by the different neurons in the classifier network 306.

In general, differential Boolean logic generator 406 essentially implements a differentiable neural logic (dNL) network 412 that can learn and explicitly represent Boolean logic formulas and, in particular, disjunctive normal form (DNF) formulas 414, through the execution of differential Boolean logic generator 406 and explainable decision rule generator 408. Note that since any Boolean formula can be transformed by disjunctive normal form, this allows for learning any arbitrary Boolean function. Moreover, since any decision tree can also be restated as a set of conjunctive rules, i.e., as DNF function, the dNL network can produce interpretable result similar to the decision trees.

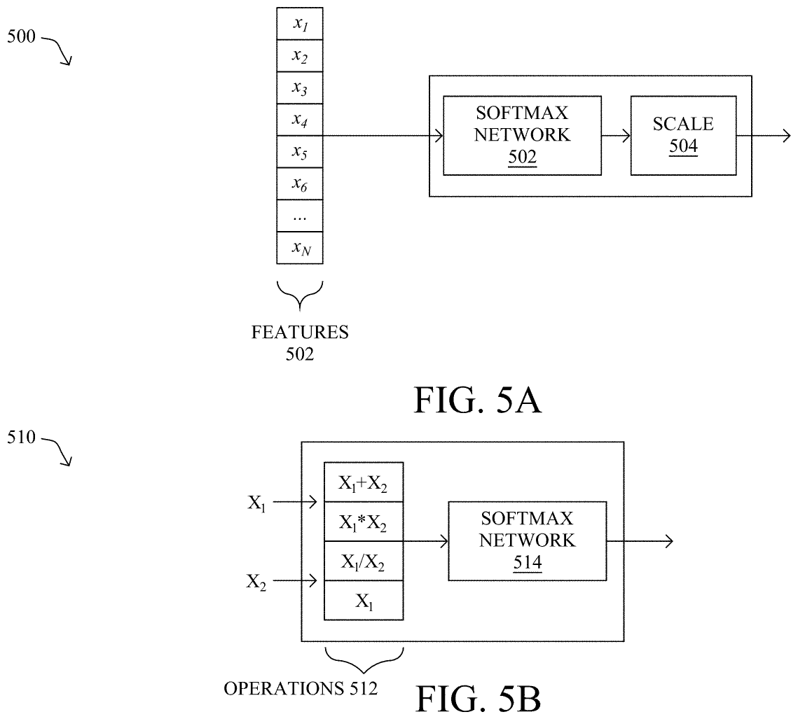

In various embodiments, differential Boolean logic generator 406 may be implemented using the building blocks shown in FIGS. 5A-5B. In particular, FIG. 5A illustrates an example feature selector block (FSB) 500 that selects one of the possible features 502 from feature disentangler 404 using a Softmax network 504 and applying a scale 506, in one embodiment. FIG. 5B illustrates an example operation selector block (OSB) 510 that selects one of the possible Boolean operations 512 that could be applied, also using a Softmax network 514, in various embodiments. In various embodiments, the possible Boolean operations 512 selectable by OSB 510 may be any or all of the following:

F(x₁, x₂)=x₁+x₂ Summation

F(x₁, x₂)=x₁*x₂ Multiplication

F(x₁, x₂)=x₁/x₂ Division

F(x₁)=a x₁+b Scaling

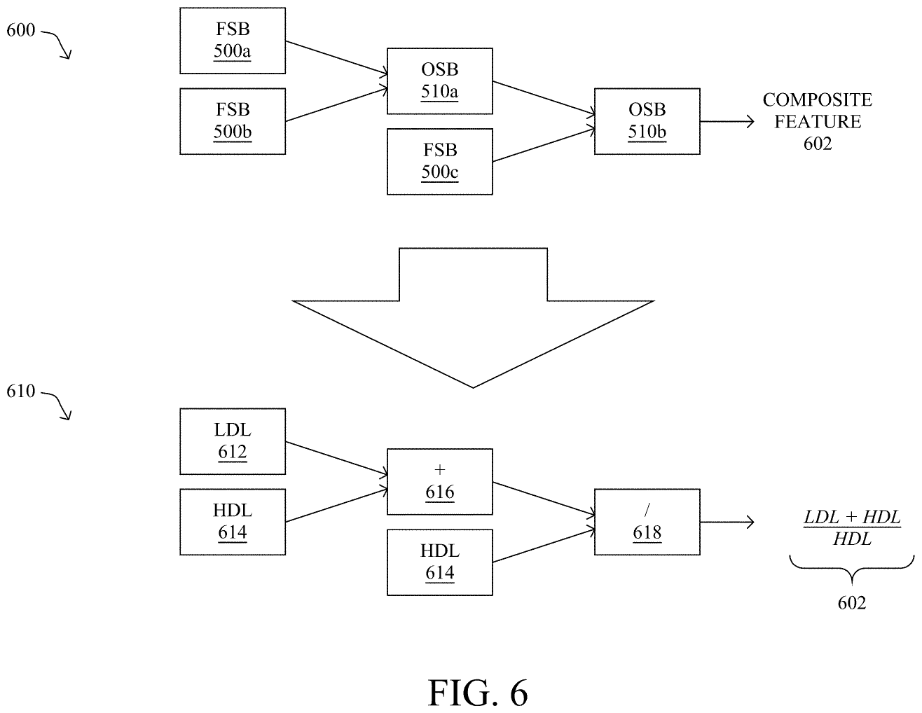

FIG. 6 illustrates an example of learning and representing composite features as Boolean functions. As shown, consider the case of an AI model that makes and inference as to whether the cholesterol measurements of a person are acceptable or not. Typically, cholesterol readings measure two classes of cholesterol: low-density lipoprotein (LDL) and high-density lipoprotein (HDL). In turn, a cholesterol ratio is often computed from these values as the total cholesterol (LDL+HDL) divided by HDL, to determine whether the person has high cholesterol.

Assume now that an AI model has been trained to take the cholesterol measurements of a person as input and output an inference as to whether that person has high cholesterol or not. To do so, the AI model may construct a composite feature from the HDL and LDL features of the input data that represents the cholesterol ratio of the person. In such a case, a cascade 600 of FSB 500 blocks and OSB 510 blocks can be constructed to learn and represent this composite feature constructed by the AI model to arrive at its inference.

Here, FSB 500a may select the LDL feature 612, while FSBs 500b-500c may select the HDL feature 614. OSB 510a may select an additive operator 616 to represent that LDL feature 612 and HDL feature 614 are summed. Likewise, OSB 510b may select the division operator to represent that the sum of LDL feature 612 and HDL feature 614 (i.e., the total cholesterol of the person) is then divided by HDL feature 614, to arrive at the composite feature 602 (i.e., the cholesterol ratio of the person).

In other words, even though the cholesterol ratio is not explicitly programmed into the AI model, it may nonetheless learn that this composite feature is important for purposes of inferring whether a person has acceptable or unacceptable cholesterol levels. Using the techniques herein, the reliance of the AI model on such a composite feature may still be captured using the building blocks shown in FIGS. 5A-5B.

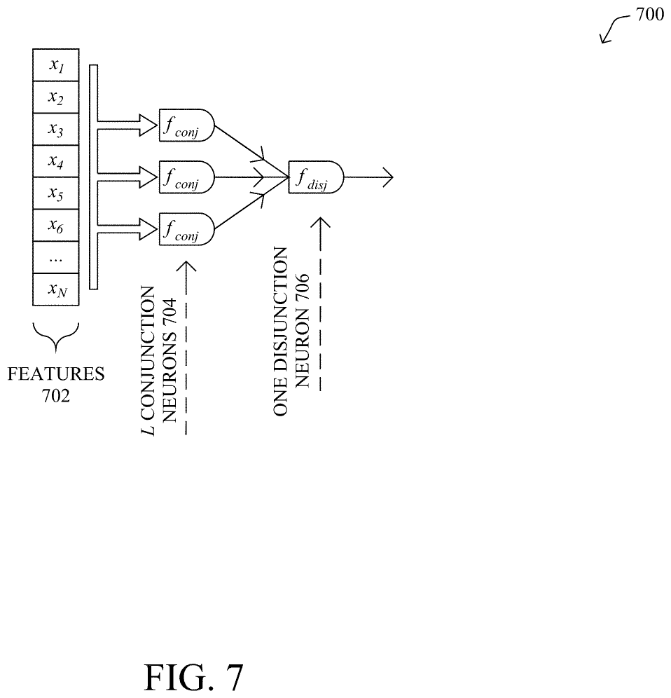

Referring again to FIG. 4 and shown in greater detail in FIG. 7, the dNL network 412 may be constructed by cascading two elementary Boolean neural networks corresponding to the Boolean conjunction and disjunction, in various embodiments. Consider the input Boolean vector to a neural conjunction consists of mᵢ, where i is an integer in the range of 1 to N and N is the dimension of the vector. The main idea behind the design of the dNL layers is to introduce a trainable (fuzzy) Boolean variable corresponding to each Boolean feature xᵢ in the set of features 702 such that it can control the inclusion (exclusion) of the element xᵢ from the final formula.

By way of example, consider a conjunction function of all the elements of features 702, i.e., x₁, x₂, . . . , x_{N}. By replacing each xᵢ in this expression with (xᵢ|not(mᵢ), where | is the Boolean disjunction, the system obtains a Boolean expression that can represent the conjunction of any subset of the elements of input, i.e., {x₁, x₂, . . . , x_{N}}. It is clear that if mᵢ is False, (xᵢ|not(mᵢ)) is equal to True, and as such, the element xᵢ is excluded and if is mᵢ True (xᵢ|not(mᵢ)) is simplified to xᵢ. Note that mᵢ is a Boolean variable and is not trainable via gradient optimization techniques. The Boolean operations of AND (&) and OR (|) are also not differentiable.

In turn, mᵢ can be replaced with the trainable expression mᵢ=mᵢ=σ(ωᵢ), where wᵢ is a trainable variable. Further, x & y can be replaced with the fuzzy relaxation of x.y and x|y with by 1−(1−x)(1−y) by employing the De Morgan's law. The resulting expression, which is a fuzzy relaxation of the conjunction function, is as follows:

$${f}_{conj} ( x ) = {\prod }_{i = 1}^{N} 1 - σ ( {ω}_{i} ) ( 1 - {x}_{i} ) )$$

The disjunction function can also be represented, in a similar manner:

$${f}_{disj} ( x ) = 1 - {\prod }_{i = 1}^{N} 1 - σ ( {ω}_{i} ) {x}_{i} )$$

These two equations can be used to form a layer of conjunction neurons 704 and a disjunction neuron 706, respectively, as shown in FIG. 7.

By applying the aforementioned differentiable logic network to the feature layer of a neural network, as in in FIG. 4, architecture 400 is able to learn the classification rules in form of easily interpretable Boolean formulas. Since the whole model is differentiable, it can be trained via standard gradient optimization techniques which makes this model applicable to a wide range of applications. Without posing any restriction, the membership variables mᵢ=σ(ωᵢ) are fuzzy Boolean values in the range of 0 and 1. As such, the resulting DNF rules are fuzzy and cannot be easily interpreted. To resolve this, a penalty term may be added to the aggregate loss function of the supervised model which discourages the fuzzy values within the range [0,1]. For instance, the loss function may be rewritten:

$${ℒ}_{aggregate} = {ℒ}_{supervised} + {λ}_{fuzzy} {ℒ}_{fuzzy}$$

$${ℒ}_{fuzzy} = \frac{1}{{N}_{w}} {\sum }_{i = 1}^{{N}_{w}} {w}_{i} ( 1 - {w}_{i} )$$

Where N_{w} is the number of membership weights and lambda_fuzzy is a constant that is greater than zero. Please note that the choices for the penalty term is not limited to the above definition and, in general, can be any differentiable function which discourages fuzziness. In this manner, explainable decision rule generator 408 may generate formulas 414. The end result of the proposed model is a set of rules corresponding to each conjunction function in the DNF function. These rules can then be stated as a series of conditions based on certain values of the feature vector, and provided for display as insight information to help explain the inferences made by the AI model under scrutiny.

According to various embodiments, another potential explainability insight consists of providing example(s) from. the training dataset used to train the AI model in conjunction with its inference. For instance, the system may show the user one or more examples of what the AI model deems to be closest to that of the input data and with respect to the inference.

Consider the task of classifying input image 302, which depicts a bird. In such a case, the inference by the AI model/classifier may be a specific type of bird (e.g., a blue jay, sparrow, etc.), which it may make based on the various features that it detects in input image 302 (e.g., beak type, color, wing type, etc.). The idea here is that the system can also provide example images of other birds that exhibit features that also trigger the same neurons of the classifier as that of input image 302. To do so, the techniques herein propose ‘memorizing’ the neurons of interest in the classifier and matching them to examples from its training dataset.

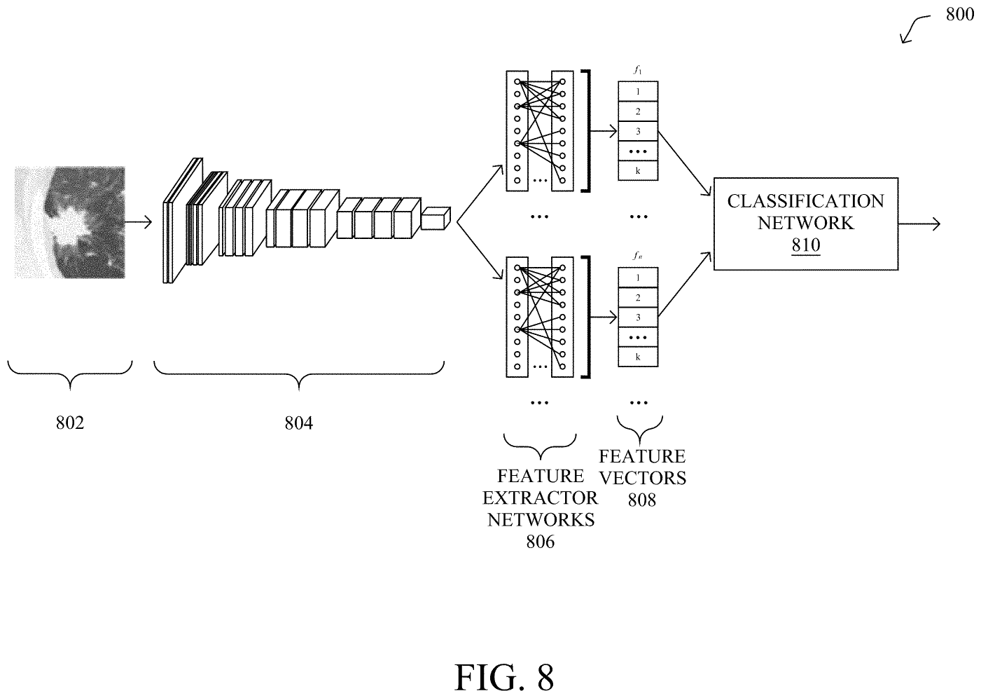

FIG. 8 illustrates an example architecture 800 for memorizing neural networks, according to various embodiments. In this architecture, the assumption is that the feature layer of a convolutional neural network is further processed by a set of n-number high level feature extractor networks 806, each generating a vector of size k as a compact representation of some high-level features, collectively shown as feature vectors 808. In other words, given an input image 802, which may be processed by layers 804 (e.g., a VGG network, etc.) and feature extractor networks 806, sets of feature vectors 808 are produced for use by a classification network 810.

Depending on the classification network architecture, the feature representations in feature vectors 808 may be vectors of binary values or real vectors of embeddings. For instance, in order to generate decision tree-like inference rules, the real vectors can be converted to vectors of binary features by applying a Softmax function and use a differentiable decision tree classifier to generate inference rules. Alternatively, a shallow (e.g., 2-3 layers), fully-connected layer could be connected to the real valued vector of embeddings, to create class likelihood estimates. Based on the type of the classifier networks used in this scheme various levels of explainability can be obtained. Nonetheless, these explanations can only be meaningful if they are explained in terms of some higher-level concept, hidden in some manner in the compact representations in any of the n vectors of k dimensional embedding features. For instance, even if a ‘black box’ classifier network is used, any inference outcome can still be attributed to the most influential feature vectors.

For the sake of argument, assume input image 802 is a medical image and that the inference by the AI model assigns a ‘cancerous’ class to input image 802, based on the effects of feature vectors f₁ and f₃ out of a total of five feature vectors. Without any understanding of what these two features represent, this explanation has little practical value. The main idea here to remember/learn a certain group of representative images that were used during the training and use them as a means of explanation. Since the entangled features are learned without any provided labels (i.e., in an unsupervised manner), the high level concepts that they represent are not clear/known in advance.

In some embodiments, the techniques herein allow the image(s) in the training dataset to be provided as explainability insights that are ‘closest’ to the current values of the obtained embedding vectors. The meaning of the high-level feature can then be understood visually using analogous circumstances.

There are certain considerations and algorithms that are necessary for this approach to work. Below are few approaches and considerations for finding the best example matches within the training data.

High level feature vectors: the feature vectors f₁, f₂, . . . , fₖ, are learned indirectly via the classification loss measured at the overall model's output deviation compared to the ground truth. This means that the system needs to make sure that, the representation learned in each of the feature vectors are due to some local features in the input image. This localization would make the analogy between the image and each corresponding representative sample more useful and explanatory.

There are many ways to learn these localized features. In the most simplistic fashion, in one embodiment, the system may apply the global pooling layer to the output of last convolutional layer of the AI model. The index of the maximizing point in the grid will be used to select the region of interest. This will create a rectangular point of interest window for each feature vector 808. The downside to this approach is that it assumes that all regions of interests have the same size. In a more sophisticated approach, in another embodiment, the system may learn separated filters that act as mask for each high-level feature. These masks can be created by using a Softmax function applied on the linear transformation of the output of the last CNN layer. Note also that the Softmax output could be multimodal, as well. To remove the other modes from the mask, a Gaussian filter centered at the maximum point in the grid could be used and then the mask multiplied against this filter, to generate a unimodal mask.

Depending on the circumstances, the training phase for such an approach may take either an offline form or an online form, in various embodiments:

Offline algorithm: For any embedding feature vector fᵢ, the system can find the similar images or other form of data in the training dataset corresponding to that feature. In the most simplistic embodiments, a Euclidean or dot product metric could be used with the current fᵢ vector to each of the corresponding feature vectors generated during the training (at the epoch of the training algorithm). One of the challenges with this approach is that it will be difficult to communicate the class/type of the corresponding high-level concept. This problem can be resolved by using an unsupervised clustering algorithm on a post-hoc manner to partition the training data based on the values of that particular feature vector embedding into C predefined number of classes, in one embodiment. In this case, instead of showing the crossest samples to the current embedding vector, the system will show the representative samples of winner class.

This approach leas several benefits compared to the naïve closest neighbor approach, First, using this approach we do not need to store the feature vectors for all the training data which can be prohibitive because of storage or privacy concerns. Moreover, the representative samples for each class can be carefully selected by careful observation of the samples closest to the centroid of each cluster. This will help to further polish and clarify the generated explanation. For the clustering algorithm, a variant of k-means clustering or another suitable clustering approach could be used. In a more sophisticated embodiment, agglomerative hierarchical clustering algorithms could be used to define more levels of explanation. However, the need to use more complex clustering algorithm is usually a good indicator the current high-level feature is not simple and needs to be broken down into newer high-level features.

Online algorithm: As would be appreciated, the offline algorithm in previous section may become impractical when the size of training dataset is very large. In such cases, processing the training data as done in clustering algorithms become impractical. Even the naïve closest neighbors may require huge amount of data. Here, the techniques herein further propose an online algorithm based in the idea of reservoir sampling, in some embodiments. During the training phase, every neuron in the neural network corresponding to the feature layer will be trained to remember the set of representative images that traverse that neuron in the classification stage. This can be achieved by training the neural network of the AI model using a training dataset, as normal. However, after that training is complete, the system may begin re-classifying all of the training set samples through the neural network. This time, though, as the neural network is traversed, each neuron in the feature layer may be configured to store/remember this data sample in its small collection of representative samples that is referred to herein as its ‘reservoir’.

In various embodiments, all samples of the training dataset could be re-classified in such a way or, alternatively, only a subset thereof (e.g., selected randomly, etc.), until there is a reasonable reservoir size for all the neurons. Training datasets tend to be large, though. Therefore, if the entire training dataset is processed in such a way, this will greatly increase the storage costs in the neural network data structure. To keep the size of the NN reasonable contained by using a technique similar to the classical reservoir sampling, only samples that are furthest from each other (measured in either Euclidean or other distance measures) may be retained, but still part of the cluster of training samples that are represented by that neuron. The key intuition here is that the representation of training samples needs to be maximized by eliminating training samples that are close to each other to be most efficient in terms of storage complexity of the neural network.

Classification phase: During the classification phase, the input query traverses different layers of the neural network/AI model as usual. However, in addition to just traversing, it also collects all the sample reservoirs from all the neurons along the feature layer for showcasing them as part of the classification explanation. In various embodiments, the full set of sample reservoirs may be collected or, alternatively, the set may be trimmed down to a small number of samples within the sample reservoirs that are closest (e.g., using a Euclidean or other distance measure), so that the most relevant and closest data samples are selected for visualization as part of the query explanation.

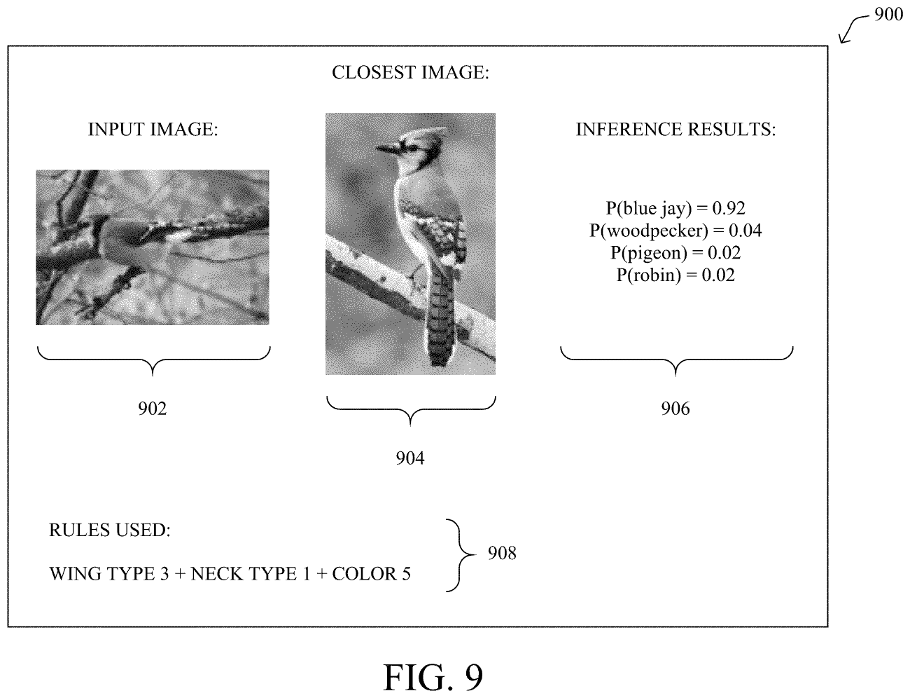

FIG. 9 illustrates an example display 900 of classification results with explainability insights, according to various embodiments. As shown, assume that an input image 902 is assessed by an AI model of the system, to classify it as depicting a bird of a certain type. In such a case, the AI model (e.g., an image classifier) may output inference results 906 that represent the probabilities of image 902 showing a bird of different types. Here, the system has predicted with the highest probability that image 902 shows a blue jay, with other bird types have much lower probabilities.

To aid in the understanding as to how the AI model arrived at inference results 906, the closest image 904 from the training dataset used to train the model may also be provided in conjunction with inference results 906. When presented on an electronic display, this allows the user to visually review the various features of both images, to better understand how the AI model assessed image 902. This can be particularly useful, even in cases in which inference results 906 are ‘wrong,’ but images 902-904 exhibit similar features, nonetheless.

In further embodiments, the Boolean rules 908 extracted from the AI model to generate inference results 906 could also be presented for display in conjunction with inference results 906. For instance, Boolean rules 908 may indicate that the AI model predicted that image 902 shows a blue jay based on it having a certain wing type (e.g., ‘wing type 3’), neck type (e.g., ‘neck type 1’), color (e.g., ‘color 5’), etc.

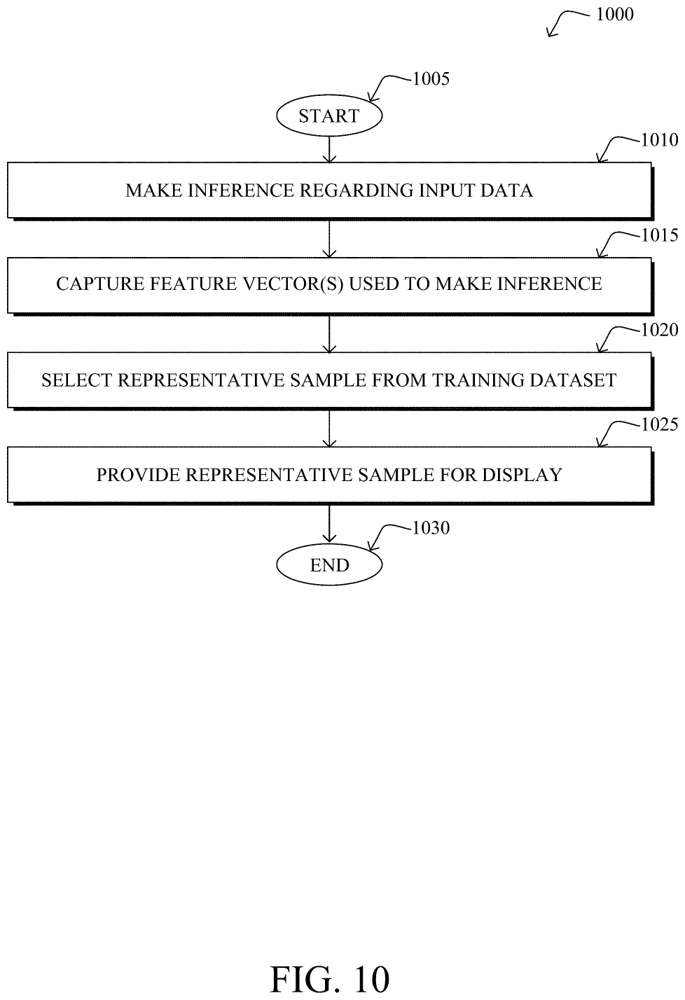

FIG. 10 illustrates an example simplified procedure 1000 (e.g., a method) for providing explainability insights for an artificial intelligence model, in accordance with one or more embodiments described herein. For example, a non-generic, specifically configured device (e.g., device 200), may perform procedure 1000 by executing stored instructions (e.g., AI process 248). The procedure 1000 may start at step 1005, and continues to step 1010, where, as described in greater detail above, the device may make an inference regarding input data using an artificial intelligence model. In one embodiment, the artificial intelligence model comprises a classifier. In another embodiment, the artificial intelligence model comprises a neural network. In a further embodiment, the input data comprises an image.

At step 1015, as detailed above, the device may capture one or more feature vectors used by the artificial intelligence model to make the inference. For instance, in the case of the input data comprising an image of a bird, the one or more feature vectors may indicate various features of the bird, such as its wing type, neck type, color, etc.

At step 1020, the device may select, based on the one or more feature vectors, a representative sample from a training dataset used to train the artificial intelligence model, as described in greater detail above. In one embodiment, the device may do so by determining a distance between one or more feature vectors associated with the representative sample to the one or more feature vectors used by the artificial intelligence model to make the inference. In one embodiment, the one or more feature vectors associated with the representative sample are captured during training of the artificial intelligence model in part by clustering feature vectors associated with the training dataset. In another embodiment, the one or more feature vectors associated with the representative sample are captured during training of the artificial intelligence model in part by configuring one or more neural network layers of the artificial intelligence model to capture them when the representative sample as used as input to the artificial intelligence model.

At step 1025, as detailed above, the device may provide the representative sample for display in conjunction with the inference. In some embodiments, the device may also provide a Boolean decision rule associated with the artificial intelligence model for display, to explain the inference. In one embodiment, the Boolean decision rule is learned by applying a differentiable logic network to a feature layer of the artificial intelligence model. In another embodiment, the Boolean decision rule comprises features in one or more feature vectors used by the artificial intelligence model to make the inference. Procedure 1000 then ends at step 1030.

It should be noted that while certain steps within procedure 1000 may be optional as described above, the steps shown in FIG. 10 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore, allow explainability insights to be provided for an AI model, to aid in the understanding as to how the model made an inference. In some instances, such an insight may take the form of one or more examples from the training dataset for the model, to allow the user to review examples that the model considers to be similar to that of the input data. In further instances, the insights also may take the form of Boolean rules that represent the reasoning used by the model to make the inference.

While there have been shown and described illustrative embodiments that provide for artificial intelligence with explainability insights, it is to be understood that various other adaptations and modifications may be made within the spirit and scope of the embodiments herein. In addition, while certain protocols are shown, other suitable protocols may be used, accordingly.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

1. A method comprising:
making, by a device, an inference regarding input data using an artificial intelligence model;
capturing, by the device, one or more feature vectors used by the artificial intelligence model to make the inference;
selecting, by the device and based on the one or more feature vectors, a representative sample from a training dataset used to train the artificial intelligence model; and
providing, by the device, the representative sample for display in conjunction with the inference.

2. The method as in claim 1, wherein the artificial intelligence model comprises a classifier.

3. The method as in claim 1, wherein the input data comprises an image.

4. The method as in claim 1, wherein the artificial intelligence model comprises a neural network.

5. The method as in claim 1, wherein selecting the representative sample comprises:
determining a distance between one or more feature vectors associated with the representative sample to the one or more feature vectors used by the artificial intelligence model to make the inference.

6. The method as in claim 5, wherein the one or more feature vectors associated with the representative sample are captured during training of the artificial intelligence model in part by clustering feature vectors associated with the training dataset.

7. The method as in claim 5, wherein the one or more feature vectors associated with the representative sample are captured during training of the artificial intelligence model in part by configuring one or more neural network layers of the artificial intelligence model to capture them when the representative sample as used as input to the artificial intelligence model.

8. The method as in claim 1, further comprising:
providing a Boolean decision rule associated with the artificial intelligence model for display, to explain the inference.

9. The method as in claim 8, wherein the Boolean decision rule is learned by applying a differentiable logic network to a feature layer of the artificial intelligence model.

10. The method as in claim 8, wherein the Boolean decision rule comprises features in one or more feature vectors used by the artificial intelligence model to make the inference.

11. An apparatus, comprising:
one or more network interfaces;
a processor coupled to the one or more network interfaces and configured to execute one or more processes; and
a memory configured to store a process that is executable by the processor, the process when executed configured to:
make an inference regarding input data using an artificial intelligence model;
capture one or more feature vectors used by the artificial intelligence model to make the inference;
select, based on the one or more feature vectors, a representative sample from a training dataset used to train the artificial intelligence model; and
provide the representative sample for display in conjunction with the inference.

12. The apparatus as in claim 11, wherein the artificial intelligence model comprises a classifier.

13. The apparatus as in claim 11, wherein the input data comprises an image.

14. The apparatus as in claim 11, wherein the artificial intelligence model comprises a neural network.

15. The apparatus as in claim 11, wherein the apparatus selects the representative sample by:
determining a distance between one or more feature vectors associated with the representative sample to the one or more feature vectors used by the artificial intelligence model to make the inference.

16. The apparatus as in claim 15, wherein the one or more feature vectors associated with the representative sample are captured during training of the artificial intelligence model in part by clustering feature vectors associated with the training dataset.

17. The apparatus as in claim 15, wherein the one or more feature vectors associated with the representative sample are captured during training of the artificial intelligence model in part by configuring one or more neural network layers of the artificial intelligence model to capture them when the representative sample as used as input to the artificial intelligence model.

18. The apparatus as in claim 11, wherein the process when executed is further configured to:
provide a Boolean decision rule associated with the artificial intelligence model for display, to explain the inference.

19. The apparatus as in claim 18, wherein the Boolean decision rule is learned by applying a differentiable logic network to a feature layer of the artificial intelligence model.

20. A tangible, non-transitory, computer-readable medium storing program instructions that cause a device to execute a process comprising:
making, by the device, an inference regarding input data using an artificial intelligence model;
capturing, by the device, one or more feature vectors used by the artificial intelligence model to make the inference;
selecting, by the device and based on the one or more feature vectors, a representative sample from a training dataset used to train the artificial intelligence model; and
providing, by the device, the representative sample for display in conjunction with the inference.
